(19) United States
(12) Patent Application Publication
(10) Pub. No.: US 2026/0317080 A1
(43) Pub. Date: Oct. 15, 2026

(54) ASSEMBLY FOR THE CONVEYANCE AND UNLOADING OF FRUIT AND VEGETABLE PRODUCTS

(71) Applicant: Unitec S.p.A., Lugo (IT)

(72) Inventor: Luca BENEDETTI, Ravenna Frazione Savarna (IT)

(73) Assignee: Unitec S.p.A., Lugo (IT)

(21) Appl. No.: 19/100,955

(22) PCT Filed: Jul. 7, 2023
(86) PCT No.: PCT/EP2023/068842

§ 371 Date: Feb. 4, 2025

(30) Foreign Application Priority Data
Aug. 4, 2022 (IT) 102022000016602

(51) Int. Cl. B65G 47/52; B07B 4/00; B65G 13/04; B65G 43/08

(52) U.S. Cl. CPC B65G 47/525; B65G 43/08; B07B 4/00; B65G 13/04; B65G 2201/0211

(57) ABSTRACT

An assembly for the conveyance and unloading of fruit and vegetable products, which comprises:
means for cyclic movement along a predefined advancement trajectory of at least one series of axially symmetrical supporting elements for fruit and vegetable products, which are arranged aligned along the trajectory with the longitudinal axis of symmetry transverse to the trajectory; at least some pairs of consecutive elements are configured to define respective seats for corresponding products, which can be arranged substantially above respective interspaces between corresponding consecutive elements, resting along the lateral surfaces thereof,
at least one station for unloading the products in transit, which comprises at least one primary dispenser of fluid under pressure, equipped with at least one first nozzle.

The first nozzle is arranged at a vertical elevation that is lower than the vertical elevation of a predefined unloading point of the trajectory and is configured to point a first jet of the fluid substantially toward the unloading point.

The present invention relates to an assembly for the conveyance and unloading of fruit and vegetable products.

In the sector of packaging and the distribution of fruit and of fruit and vegetable products in general, the use is known of at least partially automated plants or lines, which are fed with indiscriminate masses of a specific type of product and are designed (for example) to carry out activities of cleaning, washing, checking, sizing, selection and/or packaging.

In particular, such plants are capable of acquiring information relating to one or more parameters of interest, such as for example color, shape, dimensions, sugar content, ripeness, possible rot, or weight, in order to enable a plurality of selective unloading devices to transfer each product to the most appropriate collection station, as a function of the information collected previously, and accumulate homogeneous masses of products downstream.

At least at the unloading devices, the movement of the products is often left to a succession of rollers or other axially symmetrical elements, which are arranged with their longitudinal axis of symmetry perpendicular to the advancement direction, which is imposed by a chain or by a belt which in turn is driven by a motor.

In this context, each product advances while it is located above the interspace between two consecutive rollers, resting on the mutually facing lateral surfaces of these rollers.

To the side of the ideal advancement trajectory imposed on the products, unloading devices are positioned (one for every different collection station), which in such context are equipped with dispensers of compressed air that produce a jet pointed horizontally and perpendicular to the path of advancement, at a vertical elevation slightly above the top of the rollers, so as to be able to intercept the products arranged as explained above and cause them to fall to the side, into the respective collection stations.

This is a very common implementation solution, adopted for various types of fruits and other fruit and vegetable products of small and medium dimensions, which however is not devoid of drawbacks.

It should be noted in fact that among the products that can be conveyed and ejected in the manner just described there are also walnuts, hazelnuts, peanuts and other nuts, which pose peculiar problems for the companies that make these assemblies.

In fact, the rollers and the interspaces are designed and dimensioned as a function of the average bulk of the whole nut. Not infrequently however, and for various reasons, the rollers receive fragments of nut, of dimensions and shape that can differ appreciably from those for which the system is designed: this causes a problem of considerable interest, and one that is not easy to solve, for the companies that make these assemblies. In fact, owing to the smaller dimensions, the fragments can slip between the rollers and become stuck in the interspace, trapped between the lateral surfaces of the rollers, at a lower vertical elevation than that at which whole products normally advance (and toward which the jets of air responsible for the expulsion are pointed).

Therefore, it is impossible to make the fragments fall correctly into a dedicated collection station, as would be desired, not only because these fragments too have an economic value for the market, but also because, by continuing downstream in an uncontrolled manner, they can compromise the operation of the plant, by clogging up the interspaces or even damaging delicate components. More simply, uncontrolled fragments that move along the line can generate debris and dust that make it impossible to maintain the high standards of cleanliness and hygiene that these plants need to meet.

Similar problems to those posed by fragments can also be generated by whole products (be they nuts or other types of product), when the masses with which the plant is fed have a high degree of heterogeneity in terms of dimensions and shapes, such that the chosen dimensioning for the rollers and the interspace are found to be inadequate to correctly handle the products that are furthest from the average values. More simply, products that are oblong in shape (with perceptible differences between at least one dimension and the others) can also pose the same problems if, as often happens, the orientation with which they are delivered to the rollers cannot be predicted in advance.

The aim of the present invention is to solve the abovementioned problems, by providing an assembly for the conveyance and unloading of fruit and vegetable products that is capable of effectively handling simple fragments, oblong products and/or products that have greatly heterogeneous shapes and dimensions.

Within this aim, an object of the invention is to provide an assembly that is capable of effectively unloading not only whole products but also any fragments thereof.

Another object of the invention is to provide an assembly that ensures a high reliability of operation.

Another object of the invention is to provide an assembly that adopts a technical and structural architecture which is an alternative to that of conventional sets.

Another object of the invention is to provide an assembly that can be easily implemented using elements and materials that are readily available on the market.

Another object of the invention is to provide an assembly that is low-cost and safely applied.

This aim and these and other objects which will become more apparent hereinafter are achieved by an assembly according to claim 1.

Further characteristics and advantages of the invention will become more apparent from the description of a preferred, but not exclusive, embodiment of the assembly according to the invention, which is illustrated by way of non-limiting example in the accompanying drawings wherein:

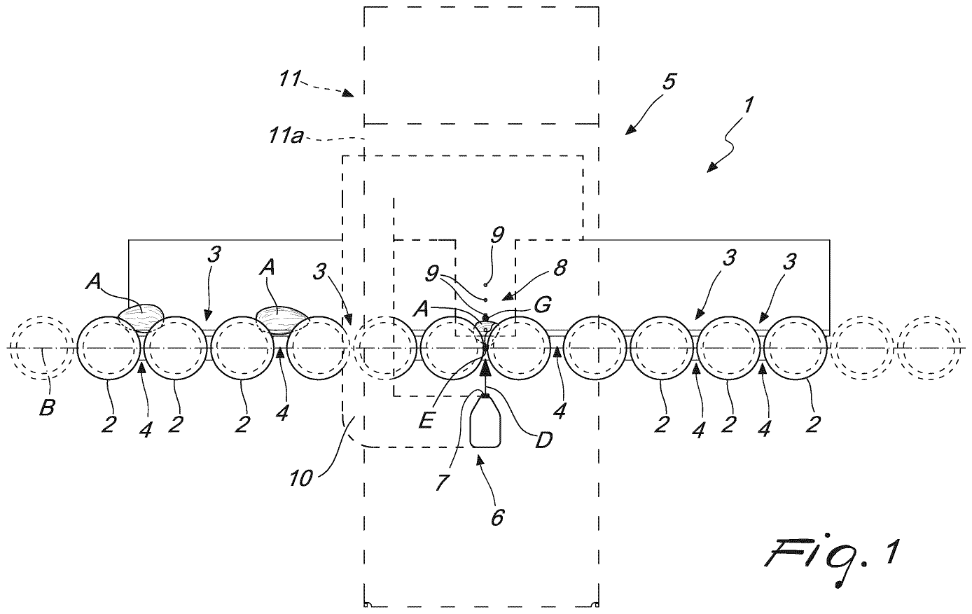

FIG. 1 is a side view of the assembly according to the invention, with some components partially shown in dotted lines, with a first possible distribution of fruit and vegetable products along its seats,

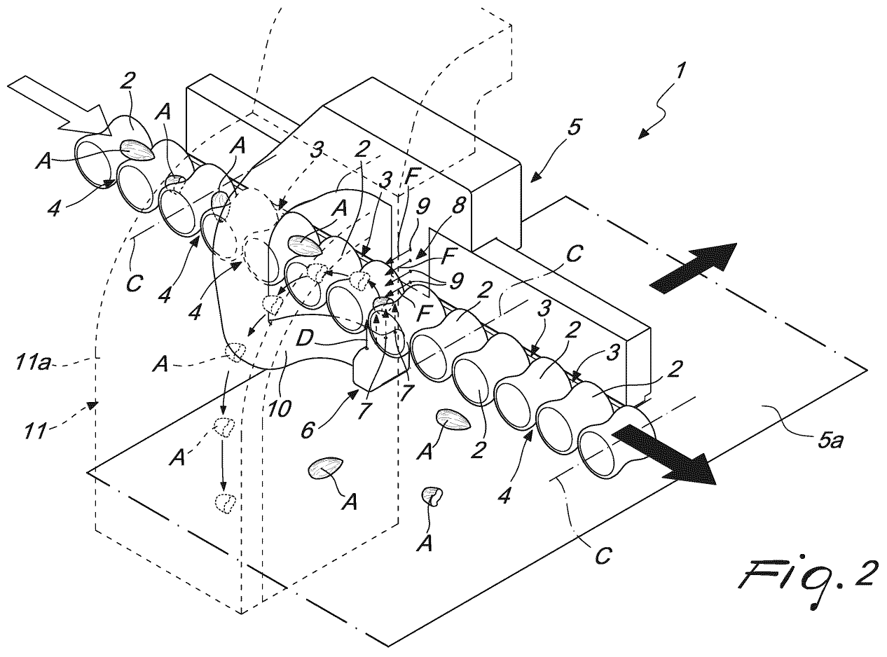

FIG. 2 is a perspective view of the assembly of FIG. 1, with some components shown in dotted lines, with a second possible distribution of fruit and vegetable products along its seats;

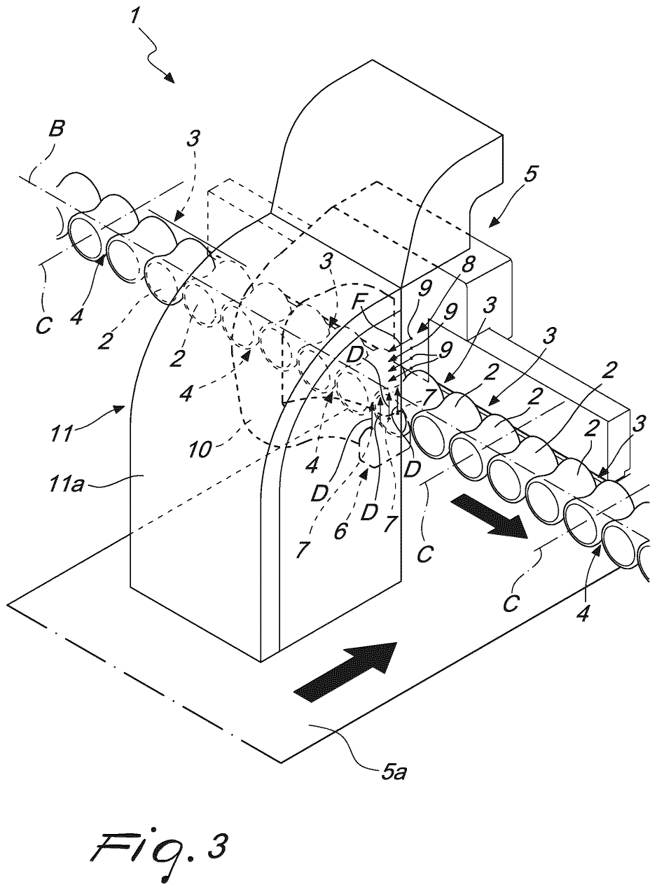

FIG. 3 is a perspective view of the assembly of FIG. 1, without fruit and vegetable products;

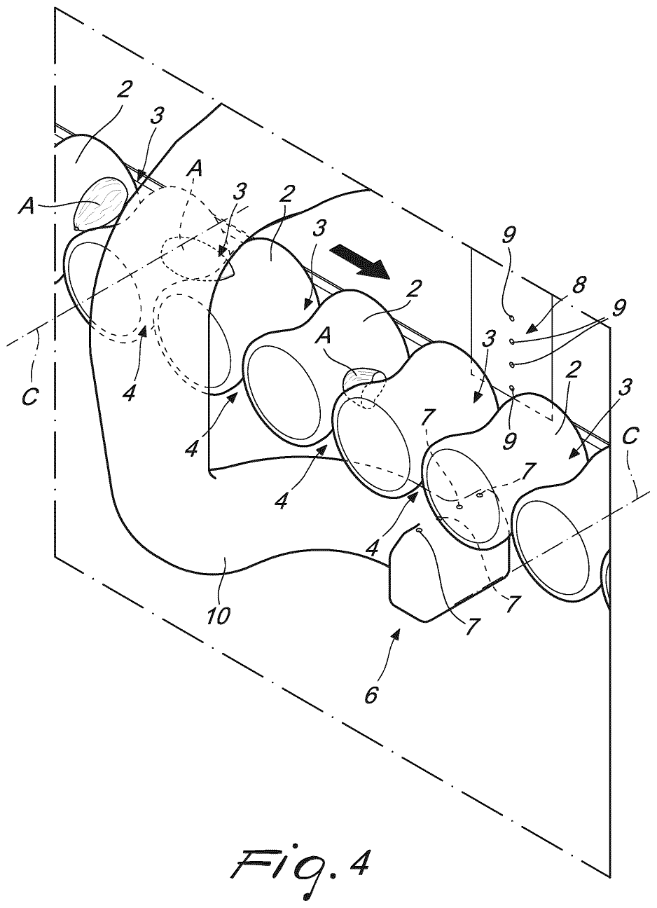

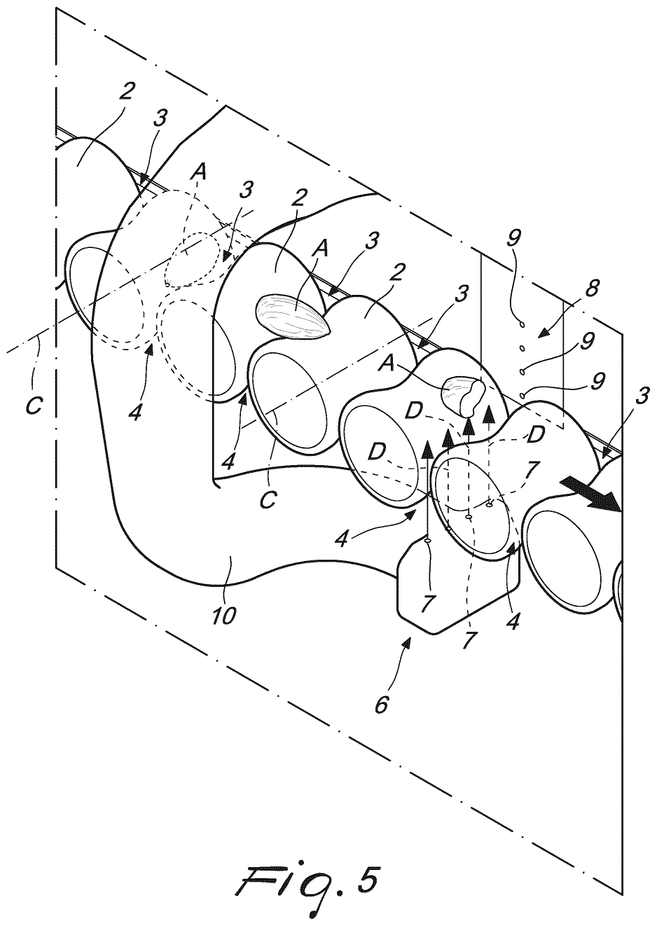

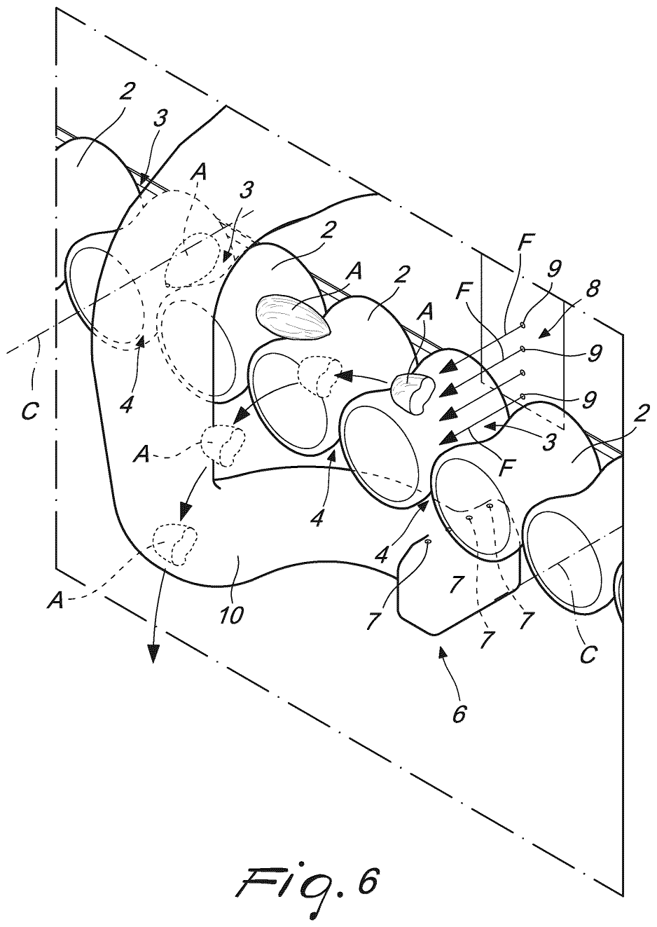

FIGS. 4 to 6 are perspective views of a detail of the assembly of FIG. 1, showing the operation in sequence;

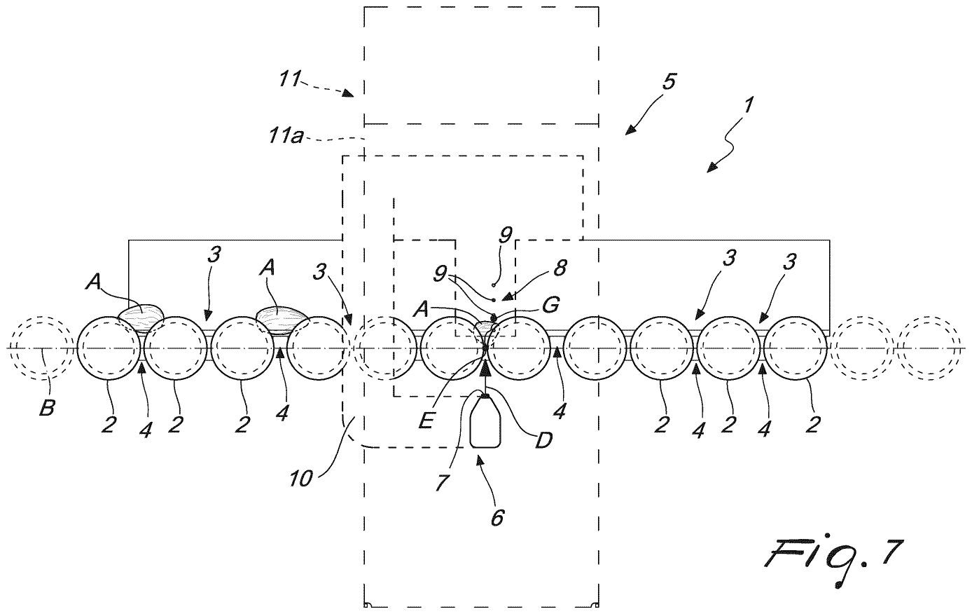

FIG. 7 is a variation of embodiment of the assembly of FIG. 1.

With particular reference to the figures, the reference numeral 1 generally designates an assembly for the conveyance and unloading of fruit and vegetable products A.

The scope of protection claimed herein extends to the use of the assembly 1 for the conveyance and the unloading of any fruit and vegetable product A (fruit, vegetables etc.): in the preferred application however, the products A belong to the category of nuts (they are almonds for example, as in the accompanying figures) or they are other types of fruit of small or medium dimensions (which can therefore be more easily unloaded or in any case moved in the manner that will be explained below).

Even more specifically, the preferred (but not exclusive) application of the assembly 1 is in plants for processing nuts, which should be conveyed whole (like the two products A on the left in FIG. 1), but which sometimes are delivered to the assembly 1 in fragments (like the one in the center, in FIG. 1). More generally, the particularities of the assembly 1 become evident when it is used for the conveyance and the unloading of products A that are presented with a high variability of dimensions and/or of shape and/or when the products A are oblong in shape, and may be delivered to the assembly 1 with any orientation.

Usually the assembly 1 is used for conveying a specific type of fruit and vegetable product A and is therefore configured and dimensioned as a function thereof. At the same time, the scope of protection claimed herein in any case includes the possibility that the assembly 1 can convey different types of products A, simultaneously or following a version change.

The assembly 1 comprises means for cyclic movement along a predefined advancement trajectory B of at least one series of axially symmetrical supporting elements 2 for fruit and vegetable products A.

In such context, in the present discussion the terms “upstream” and “downstream” are therefore used (in accordance with common practice) precisely with reference to the trajectory B and to the direction of advancement imposed on the elements 2 and therefore on the products A (from left to right in the accompanying figures).

Typically, but not necessarily, the means cyclically move the elements 2 along a closed path that comprises at least one straight section, horizontal or slightly inclined, along which the elements 2 convey the products A, and which therefore defines the trajectory B (illustrated for the sake of simplicity only in FIGS. 1, 3 and 7, and to be understood in general as the location of the points described during the conveyance of the products A from the center of gravity of each element 2). Obviously, the path also comprises a return portion, where the elements 2 are returned one after the other to the cycle start position and along which, obviously, they do not convey the products A.

The elements 2 are arranged aligned (in a row, one after the other) along the trajectory B with a longitudinal axis of symmetry C that is arranged transverse (typically perpendicular and horizontal) to said trajectory B.

It should be noted that the axial symmetrical condition indicates that the shape of the element 2 can be obtained (as happens for a cylinder, a cone or a sphere) by rotating a planar figure about an axis (about the abovementioned axis C).

Specifically, the elements 2 can be rollers or cylindrical rollers, conical rollers, double-conical rollers (shaped like a diabolo), or the like, according to the specific requirements, and can optionally be able to rotate about the axis C.

It should likewise be noted that the accompanying figures show an assembly 1 provided with just one series of aligned elements 2: the possibility exists that the assembly 1 can comprise a number at will of series of aligned elements 2, which are moved along mutually parallel trajectories B.

At least some (and preferably all) of the pairs of consecutive elements 2 are configured to define respective seats 3 for corresponding products A, which can in fact be arranged substantially above respective interspaces 4 between corresponding consecutive elements 2, resting along the lateral surfaces thereof (as can be seen in the accompanying figures).

In this regard, a product A will be placed at each interspace 4 defined between respective elements 2 (in so doing saturating the assembly 1 and maximizing hourly productivity), or only some pairs of elements 2 can be used for the conveyance of products A, as in the accompanying figures.

In any case, the dimensions (and optionally the shape) of the elements 2 and of the interspace 4 that separates them are chosen as a function of the specific product A with which the assembly 1 is to be fed. In particular, as has been seen the design can be made to support and convey whole fruits (or in any case taking into account the average dimensions of the products A), but as will be seen, by virtue of the invention, it is also possible to effectively handle simple fragments or products A that are appreciably far from the design values (oblong shapes oriented differently from what is expected and/or with appreciably smaller dimensions, for example).

It should be noted that the methods with which the products A are delivered to the movement means and the methods with which the movement of the elements 2 is achieved in practice may be any, chosen by the person skilled in the art according to requirements and/or the state of the art.

Furthermore, the assembly 1 comprises at least one station 5 for unloading the products A in transit, which is responsible for making them fall from the elements 2 toward an underlying collection element: for example, the collection element can be a container of any type or even a conveyor belt 5a, which transfers the ejected products A to another destination or collection station.

In particular, the possibility exists that a number at will of unloading stations 5 are arranged along the trajectory B, so as to be able to activate the station associated with the specific destination toward which each product A is to be routed.

The unloading station 5 comprises at least one primary dispenser 6 of fluid under pressure, which is equipped with at least one first nozzle 7; the fluid under pressure can be for example compressed air. According to the invention, the first nozzle 7 is arranged at a lower vertical elevation than the vertical elevation of a predefined unloading point E of the trajectory B. The unloading point E, indicated only in FIGS. 1 and 7, is simply a specific point along the trajectory B, chosen freely according to the specific requirements, and FIGS. 1 and 7 clearly show, in a possible practical example, the different vertical elevations at which the unloading point E and the first nozzle 7 are located.

So in fact, the unloading point E is located at the intersection between the trajectory B and the straight line that ideally represents the direction of the first jet D.

Furthermore, according to the invention, the first nozzle 7 is configured to point a first jet D of the fluid substantially toward the unloading point E (and therefore toward the interspace 4 that, during the dispensing, be it intermittent or continuous, is at that point at that instant). Effectively, following the advancement of the elements 2 (and of the interspaces 4) along the trajectory B (but in any case as a function of the chosen modes and timings of activation of the primary dispenser 6, to which we will return in the discussion below), the first jet D is potentially capable of intercepting each interspace 4.

In the present description, when we mention a configuration of any nozzle, this refers to the arrangement and orientation of the nozzle, which are in fact chosen so as to be able to point the dispensed jet in the specified direction.

By virtue of the invention therefore, the first jet D is propagated upwardly from below, vertically or inclined, but in any case so as to be able to intercept each interspace 4, when it transits at the unloading point E, and therefore any products A located in the interspace 4. Such first jet D thus makes it possible to push upward any fragments or other products A that are trapped between the elements 2, in the interspace 4, so preventing them from continuing downstream (in so doing achieving from this point onward the set aim). In addition to fragments and products A of dimensions that differ appreciably from expected values, it should be noted that the solution can effectively handle oblong products A (like the almonds in the accompanying figures), which can be presented with an orientation that leads them to fall into and become stuck in the interspace 4, either because they are arranged with the larger dimension parallel to the longitudinal axes of symmetry C, or because, especially, they are arranged “dagger fashion”, with the larger dimension perpendicular to the horizontal plane (third almond on the left in FIG. 2.

In particular, in the embodiment in the accompanying figures, the first nozzle 7 is configured to point the first jet D in a substantially vertical direction, upward (the first nozzle 7 is arranged so as to be exactly below the interspace 4, when it transits at the unloading point E).

Such choice makes it possible to reduce the path imposed on the first jet D (once the vertical elevations of the first nozzle 7 and of the unloading point E have been chosen), but the possibility is not ruled out of arranging the first nozzle 7 differently with respect to the unloading point E, pointing it so that the first jet D has an inclined direction, for example if this might be useful to better control the fall path of the product A, according to the specific requirements.

More specifically, the primary dispenser 6 can comprise a plurality of first nozzles 7, which (as in the accompanying figures) are preferably arranged aligned along an ideal straight line that is horizontal and lies on a plane that is perpendicular to the trajectory B). The accompanying figures show a primary dispenser 6 provided with four first nozzles 7, but the number can be chosen freely, as a function of the requirements (a high number evidently being preferable when a thrust of greater intensity is needed on the products A, or when a greater area needs to be affected). Any consideration made in the present discussion on “a” first nozzle 7 can therefore be understood as potentially extending to “all” the first nozzles 7, or at least to “some” of them. It should be noted that the action of the primary dispenser 6 can be sufficient on its own to unload all the products A: after being subjected to the upward thrust, they can fall to the side naturally (for example because the first jet D is inclined), or by having conveyors of various types (a specific example will be given below). Evidently, since the seat 3 is defined above the interspace 4 (in which the fragments are trapped), the whole products A or products that are in any case correctly located in said interspace are also struck by the first jet D and can be ejected.

In the preferred embodiment, illustrated in the accompanying figures for the purposes of non-limiting example of the application of the invention, the unloading station 5 also comprises at least one secondary dispenser 8 of fluid under pressure; in this case too the fluid under pressure can be compressed air and more generally it can be the same as or different from the fluid of the primary dispenser 6.

The secondary dispenser 8 is arranged substantially to the side of the trajectory B and is equipped with at least one second nozzle 9 which is configured to point a second jet F of the fluid substantially toward an auxiliary point G (indicated for the sake of simplicity only in FIGS. 1 and 7), which is arranged along the path of the seats 3, as imposed by the means 2, above the unloading point E or above the contiguous portion of the trajectory B, downstream of the unloading point E. As already emphasized for the unloading point E, the auxiliary point G is also simply a specific point along the path imposed on the seats 3, chosen freely according to the specific requirements, but on condition that it is arranged above the unloading point E (as in FIG. 1) or above (any point of) a portion that is “contiguous” to the unloading point E (as in FIG. 7), i.e. the portion (of a few millimeters or centimeters) that has, as one of its ends, the unloading point E.

Since it is to the side of the trajectory B, and therefore of the elements 2 and of the products A, the second jet F (whether continuous or intermittent) transversely shifts any product A arranged in that seat 3 that is transiting the auxiliary point G at that instant, causing it to fall to the side of the advancing elements 2 (obviously, on the opposite side from the secondary dispenser 8). In this case too, following the advancement of the elements 2 along the trajectory B, progressively the second jet F can potentially strike all the seats 3 (even if as a function of the chosen modes and timings of activating the secondary dispenser 8).

It should be noted that the auxiliary point G and the unloading point E (and also the first nozzle 7) have been indicated by “enlarged dots” in FIGS. 1 and 7, in order to better illustrate their position.

The secondary dispenser 8 is therefore responsible, first of all, for intercepting and unloading the products A arranged correctly in the seats 3 (above the interspaces 4, resting on the lateral surfaces of the elements 2). Furthermore, by conveniently coordinating (as will be better explained below) the action of the two dispensers 6, 8, the second jet F can intercept those products A (fragments for example) which were lifted by the first jet D, in order to make them fall to the side of the trajectory B as well. If the objective to be pursued with the secondary dispenser 8 is simply to modify the falling of the products A lifted by the first jet D, the possibility is not ruled out moreover of pointing the second jet F toward an area above the path imposed on the seats 3.

In particular, in the embodiment in the accompanying figures, the second nozzle 9 is configured to point the second jet F in a substantially horizontal direction (the second nozzle 9 is arranged so as to be exactly at the same vertical elevation as the seats 3).

As previously with the first nozzle 7 and the first jet D, the preferred choice now described (and illustrated in the accompanying figures) makes it possible to reduce the path imposed on the second jet F, but the possibility is not ruled out of arranging the second nozzle 9 differently, making it so that the second jet F has an inclined direction, according to the specific requirements.

More specifically, the secondary dispenser 8 can comprise a plurality of second nozzles 9, which (as in the accompanying figures) are preferably arranged aligned along an ideal vertical straight line. The accompanying figures show a secondary dispenser 8 equipped with four second nozzles 9, but the number can be chosen freely, as a function of the requirements. As previously noted for the first nozzles 7, any consideration made in the present discussion on “a” second nozzle 9 can therefore be understood as potentially extending to “all” the second nozzles 9, or at least to “some” of them.

In particular, in two possible embodiments of the invention (and as a function of the chosen placement of the auxiliary point G with respect to the unloading point E), the secondary dispenser 8 is configured to generate the respective second jet F at the same instant or at an instant that follows the generation of the first jet D, performed by the respective primary dispenser 6.

Effectively, by taking care to point the second jet F approximately above the unloading point E or (preferably) at an auxiliary point G arranged above a contiguous portion, immediately downstream of the unloading point E, each option presented above evidently makes it possible to subject products A that are trapped under the seats 3, in the interspaces 4, to the joint action of the two jets D, F and therefore to cause the products A to be lifted and then fall to the side.

It should be noted in any case that there are other options for controlling and commanding the moments when to start the dispensing of the jets D, F, just as the duration and in general the dispensing criteria can be freely chosen.

In particular, in a first practical option, the dispensers 6, 8 are configured so that the jets D, F are continuously dispensed.

Alternatively, in a second embodiment of high practical interest, the jets D, F are activated only as needed (i.e. intermittently).

In particular, with reference to this latter option, the assembly 1 can comprise an electronic unit for the control and management at least of the primary dispenser 6, which is equipped with instructions for the selective activation of the dispensing of the first jet D as a function of information relating to the actual presence of a product A in the interspace 4 in transit at the unloading point E.

The electronic unit can be of any type, and for example it can be a controller, a PLC or an electronic computer; furthermore it can be dedicated solely to the functionality described herein, or it can be a controller or a PLC that also performs other tasks. Typically however, it is the same electronic element that oversees and governs the operation of the entire assembly 1 (and optionally of the plant in which it is inserted). The methods with which the electronic unit acquires the information relating to the presence of a product A in the interspace 4 can be any, and can avail of for example a video camera or a sensor arranged upstream, which are responsible for verifying the presence of the product A and are capable of communicating the information to the electronic unit.

The choice to continuously dispense the jets D, F (which ensures that all the seats 3 and all the interspaces 4 are struck, as mentioned in the foregoing pages) can be penalizing in terms of air consumption, with respect to the choice to dispense them intermittently, but advantageous in terms of the lower complexity required for the systems for controlling and commanding the dispensers 6, 8. The person skilled in the art can then choose in each instance the solution that is best suited to the circumstances, while remaining within the scope of protection claimed herein.

The electronic unit can also command the secondary dispenser 8, in particular if it too is placed to contribute to the fall of the products A expelled from the interspace 4.

Advantageously, the assembly 1 can comprise an interface for the control at least of the primary dispenser 6, which is configured to (enable a user to) adjust the dispensing duration of the first jet D and/or its flow rate value (optionally, mutually independently). In order to obtain the adjustment in practice, the interface is associated with the electronic unit described above or with another dedicated electronic element, which in any case is capable of controlling the operating parameters of the primary dispenser 6 and of the circuit to which it is connected. The interface can also enable the adjustment of the secondary dispenser 8.

It should be noted that the nozzles 7, 9 (and the dispensers 6, 8) can be part of a single dispensing device, which extends around the trajectory B and which contains, inside an outer shell 10, the channels that feed into the nozzles 7, 9 and are connected, at the other end, with the source of the fluid under pressure (for example constituted by a generator of compressed air or by a local supply of compressed air, made available to various user devices in the building that houses the assembly 1). The shell 10 can comprise a box-like body arranged at the side of the trajectory B, along which the second nozzles 9 are arranged, and from which a protrusion extends that is prolonged up until below the trajectory B, and along which the first nozzles 7 are arranged.

Usefully, the unloading station 5 comprises a deflector screen 11, which is arranged proximate to the unloading point E and is configured to convey toward a predefined destination the products A intercepted and propelled at least by the first jet D.

In particular, if only the primary dispenser 6 is present, the screen 11 can be arranged simply above the unloading point E and be suitably curved, in order to intercept the products A pushed upward by the first jet D and deviate them preferably to the side, so as to make them fall laterally with respect to the elements 2 in transit.

More generally, the screen 11 can have any shape, as a function of the specific falling path that is to be imposed on the products A (the accompanying figures show by way of example a solution in which the wall 11a opposite from the secondary dispensers 9 is substantially parabolic, at least in the upper portion).

The operation of the assembly according to the invention is evident from the foregoing description: the products A are conveyed on the elements 2 between two predefined stations, for any purpose. In the initial section, each product A is normally arranged in a respective seat 3 and remains resting on the elements 2, above the interspace 4. The products A arranged in the seats 3 can be easily intercepted by lateral puffs directed toward the seats 3, like the second jets F (although this function in any case can also be performed by the first jets D).

Likewise, any fragments or other products A of smaller dimensions and/or unusual shape can slip downward, becoming trapped in the interspace 4, to a lower vertical elevation with respect to the seat 3 (substantially, at the same vertical elevation as the longitudinal axes C of the rollers). Puffs directed toward the seats 3 are not capable of intercepting them and therefore their unloading is the responsibility, in an entirely particular and innovative manner, of the primary dispenser 6, which generates a first jet D upward from below (vertical or inclined) toward the unloading point E and therefore potentially toward each interspace 4. The products A arranged in the interspace 4 are thus pushed upward and preferably caused to fall to the side, by adopting adapted contrivances to convey them and deviate them toward the chosen falling area, for example by virtue of the additional action of the secondary dispenser 8 and/or with the aid of screens 11 or other conveying elements.

As has been seen, along the trajectory B a number at will of unloading stations 5 can be arranged: each one of them can be selectively activated in order to convey the products A to the corresponding destination. Likewise, if only products A that are correctly arranged in the seats 3 are to be conveyed to a specific destination (for example, in order to collect only whole fruits), the assembly 1 can be provided with one or more further unloading apparatuses, arranged to the side of the seats 3 and similar to the secondary dispensers 8, which are responsible simply for generating a transverse puff of compressed air (or other fluid under pressure) directed toward each seat 3, upon transit through a specific region.

In this regard, it should be noted that in an application of significant practical interest, the assembly 1 has a use in a plant in which, upstream of the unloading station(s) 5, a data acquisition system is configured to acquire information relating to at least one parameter of interest (color, shape, dimensions, sugar content, ripeness, possible rot, weight etc.) of each product A in transit and to transmit this information to the electronic unit described previously (or to another electronic element). According to methods that are known per se, the electronic unit can selectively activate one of the unloading stations 5 or other unloading apparatuses (equipped with simple transverse puffs) so as to accumulate at each destination (collection station) only mutually homogeneous products A, based on one or more parameters of interest.

As already anticipated, an unloading station 5 can likewise be activated when a fragment transits at the unloading point E, so as to route that fragment to a specific container, separate from the container(s) for whole fruits, which can be accumulated in different containers as a function of their dimensions. In order to transfer the products A to these latter containers, other stations 5 or simpler unloading apparatuses can be provided.

Likewise, the possibility is not ruled out of using a station 5 for unloading whole fruits, even just for some production cycles or batches, by temporarily deactivating the primary dispenser 6 or in any case by counting on the fact that the first jet D, by penetrating upward beyond the interspace 4, will also intercept the products A that are correctly arranged.

In any case, the assembly 1 according to the invention fully achieves the set aim, in that the first jet D, pointed toward the unloading point E, makes it possible to effectively handle (in addition to any other product A) simple fragments or oblong products A and/or products A that have greatly heterogeneous shapes and dimensions, by expelling them from the interspace 4 and in any case ensuring the unloading thereof, in so doing preventing them from continuing downstream undisturbed, transported between the elements 2.

The benefits described above are obtained with a solution that is structurally simple and is easily and practically implemented (it is simply necessary to provide the primary dispenser 6, configured according to the teachings given in the present discussion): this is an assurance of the economy and of the reliability of the assembly 1 according to the invention.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be substituted with other, different characteristics, existing in other embodiments.

In practice, the materials employed, as well as the dimensions, may be any according to requirements and to the state of the art.

The disclosures in Italian Patent Application No. 102022000016602 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. An assembly for the conveyance and unloading of fruit and vegetable products, which comprises:
means for cyclic movement along a predefined advancement trajectory (B) of at least one series of axially symmetrical supporting elements (2) for fruit and vegetable products (A), which are arranged aligned along said trajectory (B) with the longitudinal axis of symmetry (C) transverse to said trajectory (B), at least some pairs of said consecutive elements (2) being configured to define respective seats (3) for corresponding products (A), which can be arranged substantially above respective interspaces (4) between said corresponding consecutive elements (2), resting along the lateral surfaces thereof,
at least one station (5) for unloading the products (A) in transit, which comprises at least one primary dispenser (6) of fluid under pressure, equipped with at least one first nozzle (7),
characterized in that said at least one first nozzle (7) is arranged at a vertical elevation that is lower than the vertical elevation of a predefined unloading point (E) of said trajectory (B) and is configured to point a first jet (D) of the fluid substantially toward said unloading point (E).

2. The assembly according to claim 1, characterized in that said at least one first nozzle (7) is configured to point said first jet (D) in a substantially vertical direction, upward.

3. The assembly according to claim 1, characterized in that said primary dispenser (6) comprises a plurality of said first nozzles (7), preferably arranged aligned along an ideal straight line that is horizontal and lies on a plane that is perpendicular to said trajectory (B).

4. The assembly according to claim 1, characterized in that said unloading station (5) comprises at least one secondary dispenser (8) of fluid under pressure, which is arranged substantially to the side of said trajectory (B) and is equipped with at least one second nozzle (9) which is configured to point a second jet (F) of the fluid substantially toward an auxiliary point (G), arranged along the path of said seats (3), imposed by said means (2), above said unloading point (E) or above the contiguous portion of said trajectory (B), downstream of said unloading point (E).

5. The assembly according to claim 4, characterized in that said at least one second nozzle (9) is configured to point said second jet (F) in a substantially horizontal direction.

6. The assembly according to claim 4, characterized in that said secondary dispenser (8) comprises a plurality of said second nozzles (9), arranged aligned along an ideal vertical straight line.

7. The assembly according to claim 4, characterized in that said secondary dispenser (8) is configured to generate said respective at least one second jet (F) at the same instant or at an instant that follows the generation of said at least one first jet (D), performed by said respective primary dispenser (6).

8. The assembly according to claim 1, characterized in that it comprises an electronic unit for the control and management at least of said primary dispenser (6), which is equipped with instructions for the selective activation of the dispensing of said first jet (D) as a function of information relating to the actual presence of a product (A) in said interspace (4) in transit at said unloading point (E).

9. The assembly according to claim 1, characterized in that it comprises an interface for the control of at least said primary dispenser (6), which is configured to adjust the duration of the dispensing of said first jet (D) and/or of the flow rate value of said first jet (D).

10. The assembly according to claim 1, characterized in that said unloading station (5) comprises a deflector screen (11), which is arranged proximate to said unloading point (E) and is configured to convey toward a predefined destination the products (A) intercepted and propelled at least by said first jet (D).
